(19) United States
(12) Patent Application Publication
(10) Pub. No.: US 2020/0325779 A1
(43) Pub. Date: Oct. 15, 2020

(54) METHOD FOR CONSTRUCTING ENGINES OR MOTORS CONTAINED IN A CYLINDRICAL CASING

(71) Applicant: Carpyz SAS, Issy les Moulineaux (FR)

(72) Inventor: Pierre CARROUSET, Paris (FR)

(21) Appl. No.: 16/610,455

(22) PCT Filed: May 3, 2018
(86) PCT No.: PCT/EP2018/061255

§ 371 Date: Jun. 16, 2020

(30) Foreign Application Priority Data
May 4, 2017 (LU) 100192

(51) Int. Cl. F01D 5/04; F01D 1/02; F01D 5/18; F02K 3/068; F02K 3/077

(52) U.S. Cl. CPC F01D 5/048; F01D 1/023; F01D 1/026; F05D 2220/76; F02K 3/068; F02K 3/077; F01D 5/18

(57) ABSTRACT

These new thrusters simultaneously use wheels of the CARPYZ THRA “Turbo Powered Helicopter Reactor” type and wheels of the CARPYZ TaG “Bucket Turbines” type or wheels of the CARPYZ TaC “Scoop Turbines” type, representing real global technological breakthroughs for fluid mechanics. They use, upon vertical take-off of the aircraft, propellers driven by electric motors and temporarily use the required additional high vertical axial thrust that is then supplied by the reactors of the THRA wheels, which also use an energetic fluid. The CARPYZ type thrusters, due to the low diameter and weight afforded thereto, are progressively horizontally inclined and the force of the reactors is progressively replaced by that of the propellers, which then supply the flows required in order for the aircraft to travel horizontally using wings that rely on the lift of the fluid, like airplanes. Photovoltaic wings are then deployed that are like butterfly wings and this economical solution will enable voyages over longer distances. It really is the safe mass market vertical take-off car of the future that can be achieved in less than 10 years by virtual of the new CARPYZ type thrusters, the little things change everything!

### FIELD OF THE INVENTION

The present invention relates to a method for constructing engines or motors contained in a cylindrical casing, and engines or motors of this type.

### PRIOR ART

Aircraft propulsion engines, turbines for helicopters and turbines for industrial power generators, among others, use mechanical or electrical power compressors or generators, which are provided with numerous stages built with a multitude of small radial blades to be able to compress the fluids or to capture their energies.

### DISCLOSURE OF THE INVENTION

The invention discloses a method for constructing engines or motors contained in a cylindrical casing (CA1) characterised by the fact that they use a CARPYZ THRA Powered Turboprop Engine 1 type wheel according to patent publication WO2016110364 coupled to an SME+RME electric motor and, either at least one CARPYZ TaG Bucket Turbine 3 type wheel according to patent publication WO2014067823, or at least one CARPYZ TaC scoop type wheel according to application LU100749 of 28 March 2918, which is coupled to an SGE+RGE power generator, alone or combined, and which use the forces supplied to them by electric power or fuels which are introduced from the outside through orifices made in the casing 16-19 through peripheral chambers D and E or at the centre of the THRA.

CARPYZ engines combine mechanical and electrical energies, supplied from the outside and by fuels, and in very novel ways propose providing very strong axial thrusts adaptable to the needs demanded at any time by all kinds of devices, in particular so that they take off vertically. This is possible by using CARPYZ THRA Powered Turboprop Engine type wheels associated with TaG Bucket Turbines or TaC Scoop Turbines oriented upwards even despite their small diameter. These engines first employ the large thrust provided simultaneously by the propellers powered by electric motors but then particularly that provided by the turbo reactors by simultaneously using a very high energy liquid or gaseous fuel, e.g. a gas containing hydrogen or high-pressure water vapour, which momentarily generates a very great force as demanded, which is essential for vertical take-off. Then, to make the vehicle travel horizontally with wings that advance through the fluid, the engines tilt gradually towards the horizontal due to their small diameter. They thus use only the energy required by the electric motors integrated in the engines that rotate the two internal propellers placed in series, and which are much more energy-efficient than reactors. This is a move in the direction of entirely electrical aircraft after take-off, and fully environment-friendly and also leads towards achieving an overall improvement in weight.

The invention also has an engine or motor contained in a cylindrical casing (CA1) constructed by this method of construction, wherein the engine or motor comprises a CARPYZ THRA Powered Turboprop Engine wheel 1 coupled to an SME+RME electric motor and at least one CARPYZ TaG Bucket Turbine 3 type wheel or a CARPYZ TaC Scoop Turbine type wheel which is coupled to an SGE+RGE power generator, either a bucket wheel of the CARPYZ TaG type or a scoop wheel of the CARPYZ TaC type, alone or combined, and which uses the forces provided by electrical power or the fuels which are introduced from outside through orifices made in the casing 16-19 through the peripheral chambers D and E or in the centre of the THRA wheel.

### DESCRIPTION OF THE FIGURES

Other aims, features and advantages will result from the detailed description which follows with reference to the drawings given by way of non-limiting illustration, in which:

FIGS. 1 and 2 show half of a propeller cut at its axis constructed according to one possible embodiment by the method according to the invention;

FIG. 3 shows the method according to the invention with the arrangement used for the bucket wheel to rotate the shaft in a bearing whose fixed ring is connected and fixed within the fixed chamber;

FIG. 4 shows the method according to the invention with the arrangement used for the bucket wheel to rotate the motor shaft secured to the RGE rotor of a power generator whose SGE stator is connected and fixed to the outside of the fixed chamber;

FIG. 5 shows a front view of a THRA wheel with turbo inlet+propeller+peripheral chamber;

FIG. 6 shows a rear view of a THRA wheel with a peripheral circular slot and for example a tube which starts from the centre, passes into a blade and ends at the slot;

FIG. 7 shows a partial view of a wheel and the inlet of the inner duct of a blade;

FIG. 8 shows a partial view of a circular slot wheel with slot and blade entries;

FIG. 9 shows a partial view of the outlet of the fixed wheel with the fluid rotating according to the invention;

FIG. 10 shows a partial view of a TaG bucket turbine receiving the fluid that rotates it according to the invention.

### DETAILED DESCRIPTION OF THE INVENTION

The invention is a method for constructing engines or motors which are contained within a cylindrical casing (CA1) and use a wheel of the CARPYZ THRA Powered Turboprop Engine 1 type according to patent publication WO2016110364 1 coupled to an (SME+RME) electric motor and, either at least one wheel of the CARPYZ TaG Bucket Turbine 3 type according to patent publication WO2014067823, or at least one wheel of the CARPYZ TaC Scoop Turbine type according to the application LU100749 of 28 March 2918, which is coupled to an SGE+RGE power generator, with a bucket wheel of the CARPYZ TaG type or scoop wheel of the CARPYZ TaC type, alone or combined, and which use the forces supplied to them by electrical power or fuels which are introduced from the outside through orifices made in the casing 16-19 through peripheral chambers D and E or in the centre of the THRA.

These engines are contained in a casing and first use a wheel of the CARPYZ THRA Powered Turboprop Engine type.

The ambient fluid between 12 first in front and at the centre of the wheel A, whose direction of rotation right or left is predetermined by the designer, and continues its way in the inner channels B of the hollow blades of the propeller located in the centre of the wheel 1 which blows backwards and whose blades reach their largest diameter at a peripheral circular chamber C provided with at least one circular slot open towards the rear of the wheel. This wheel is made to rotate at the rear in the centre by the shaft X1 of the rotor of an SME+RME electric motor which is preferably pierced by a small diameter hole 13 in its centre from side to side.

The jets of fluid projected by the slots of the chamber of the wheel C are received by circular slots placed in line opposite in the bore of the inlet of the cylindrical fixed hollow chamber glued to the casing D, and the channels, formed by the slots which are provided with profiled blades placed inside between the cylindrical walls and determine the direction of rotation of the fluid supplied by the chamber C.

A set of hollow radial profiled fixed blades 2 pass through the chamber fixed to the casing D, and then connect to the stators of the SME electric motor and the SGE power generator which are located in the centre of the wheel. The hollow interior of these profiled fixed blades allows for passage of the layers of electric wires 15-17 for the stators, the SME electric motor and the SGE power generator.

At the outlet of the first front circular chamber fixed to the casing D the fluid received from the slots of the chamber C continues by turning in the fixed circular chamber E which receives the energies or fuels introduced by orifices 16 from outside the casing of the engine, and which are immediately distributed in the chambers. In the case of using flammable fuels, the chambers are provided with electric sparking devices 18.

The first two chambers are followed by another fixed cylindrical chamber F that is fixed to the casing and is provided on the inside with concentric tubes at the axis of the wheel placed one inside the other and spirally wound radial blades placed internally between the cylindrical walls of this chamber which form channels as they intersect that each individually direct the flow of fuel by rotating towards the rear of the wheel.

The chamber F sends the jets of fuel through its channels by turning on the channels the buckets of a wheel of the Bucket Turbine type or scoops of a wheel of the Scoop Turbine type G which are placed in a circular manner in line with the outlet of the channels of the chamber F. The buckets or scoops fit globally on virtual cylindrical crowns when rotating. The centre of these crowns is often occupied by a propeller that blows backwards 3 and strengthens the flow provided by the THRA wheel 1.

In its centre, this propeller is fixed on the shaft X2 of the rotor of the RGE power generator. The stator of the SGE power generator is secured to the stator of the SME electric motor of the wheel of the CARPYZ THRA type and they are connected to the chamber fixed to the casing D by hollow profiled fixed radial blades which let through and direct properly direct the central flow 2 of the propeller of the wheel of the CARPYZ THRA type. These profiled hollow blades allow for passage inside them of the layers of electric wires for the motor and for the generator 15-17.

A wheel V provided with independent profiled radial blades is optionally interposed and mounted on pivots between the chamber D and the stator of the SME motor and its blades are adjustable by a rod 14 coming from the outside of the casing by passing through D. The shaft X1 of the rotor of the RME electric motor decreases in diameter towards the rear at its outlet from the motor and enters the inside of the tube of the shaft X2 of the rotor of the RGE power generator provided with bearings L in order to hold together the shafts in a manner that they remain concentric to one another.

The rotor shaft of the electric motor which decreases in diameter X1 continues through the cased shaft of the power generator X2 which receives a rotating disk plate D2 at its outlet from the power generator. The shaft of the electric motor also receives, as soon as possible after, another rotating disk plate D1 which when they are clamped together remotely by electrically remote controlled devices 22 makes it possible to join the rotation of the two shafts as required.

An electrical variant allows regulating, by means of the frequency converter used to control the speed of the electric motor, depending on the speed of the power generator possibly controlled by an encoder and/or by the electric power which it emits in order to synchronise the rotation speeds of the shafts X1 X2 as best possible.

The fixed casing of the engine is extended towards the rear and covers the rotary bucket wheel or scoop wheel and is then secured to a fixed chamber H which is placed in line with the flow outlet of the TaG bucket wheel or the TaC scoop wheel and is provided with concentric tubes placed one inside the other in accordance with those of the bucket wheel or scoop wheel and provided with spiral profiled blades placed inside between the cylindrical walls of this chamber which form channels which direct the outward direction of the fluid towards the rear of the engine 20.

The casing of the engine in this case is no longer constantly cylindrically straight, but has instead a diameter that flares CA2 or narrows towards the rear, modifying the effective energy exchange surface of the TaG bucket wheel or the TaC scoop wheel with the fuel that it receives. In this other case, the supply of fuel in the chambers is made starting from outside of the casing of the engine 19 through at least one channel which passes through the chamber fixed to the casing D and continues in the fixed profiled hollow blades 2 which go to the shaft of the rotor of the electric motor X2 to which they connect through a small chamber placed between two circular seals.

The shaft is drilled radially at this point and connected to at least one hole parallel to the axis of the shaft which is radially connected to tubes that enter the THRA wheel. Alternatively, a direct supply can be provided in this region 21. These run to the sprayers placed in the peripheral chamber of the wheel C which send either jets or mists of the fuel turning into the channels of the fixed chamber D where the orientation of the blades determines the direction of rotation of the fluids.

The fuel products introduced from outside the casing of the engine 16 into the chamber E are gaseous or liquid or partially solid, and by combustion or chemical reactions or by their temperature (such as high-pressure water vapour) can locally generate large fluid pressures that will migrate to the chamber F and will at the outlets of the channels activate the buckets of the TaG bucket wheel or the scoops of the TàC scoop wheel by making them turn.

These energy products introduced from outside the engine casing 161 into the chambers E will activate the buckets of the TaG bucket wheel or the scoops of the TaC scoop wheel which is connected and secured at its centre 11 by a propeller with its shaft X3. This shaft is either connected to that of the rotor of an electric generator of which the SGE stator is integral 10 with the outer edge of the chamber E, or it is used directly for mechanical use. In this case a bearing L is located on the shaft X3 whose fixed part is connected and secured 11 with the outer edge of the chamber E.

For information purposes, FIGS. 5 to 10 show THRA wheels and TaG bucket turbines of the CARPYZ type or scoop turbines of the CARPYZ TaC type.

FIG. 5 shows a front view of a turbo inlet+propeller+peripheral chamber wheel.

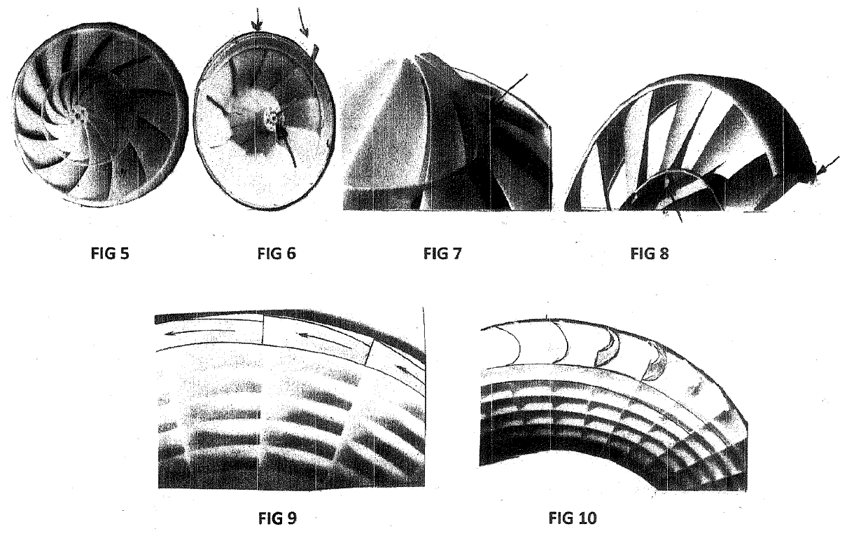

FIG. 6 shows a rear view of a wheel with a peripheral circular slot and for example a tube which starts from the centre, passes through a blade and ends at the slot.

FIG. 7 shows a partial view of a wheel and the inlet of the inner duct of a blade.

FIG. 8 shows a partial view of a circular slot wheel with slot and blade entries.

FIG. 9 shows a partial view of the output of the fixed wheel with the rotating fluid.

FIG. 10 shows a partial view of a bucket turbine which receives the fluid that makes it rotate.

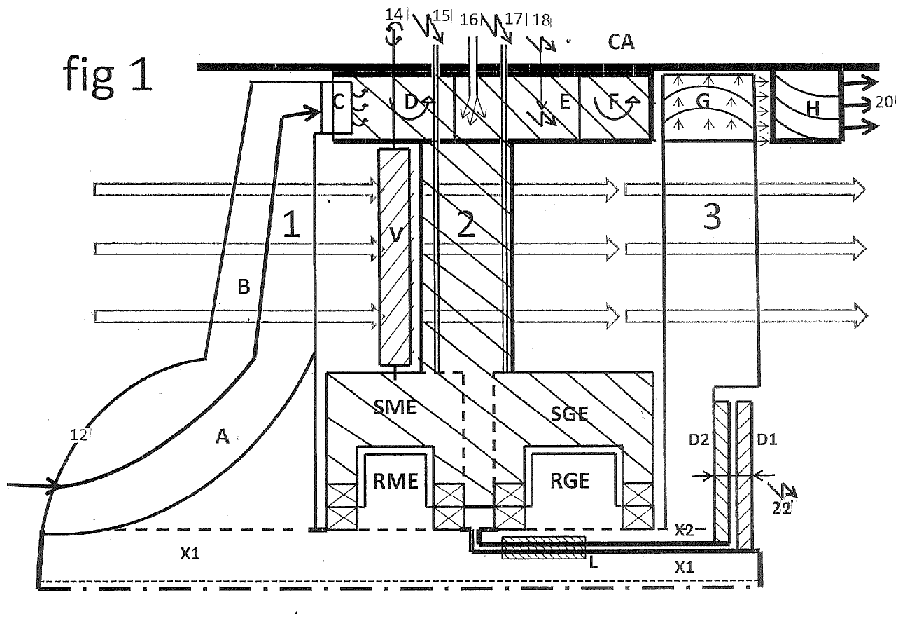

FIG. 1 shows half an engine, cut at its axis constructed according to the present application where three large hollow arrows indicate the direction of the central flow of fluid generated at the centre by the propeller 1 which then passes between the profiled radial blades of the fixed wheel 2 which connects the fixed chamber D to the stators of the SME electric motor and the SGE power generator. Then the force of the flow is increased by the central propeller of the bucket wheel or scoop wheel 3.

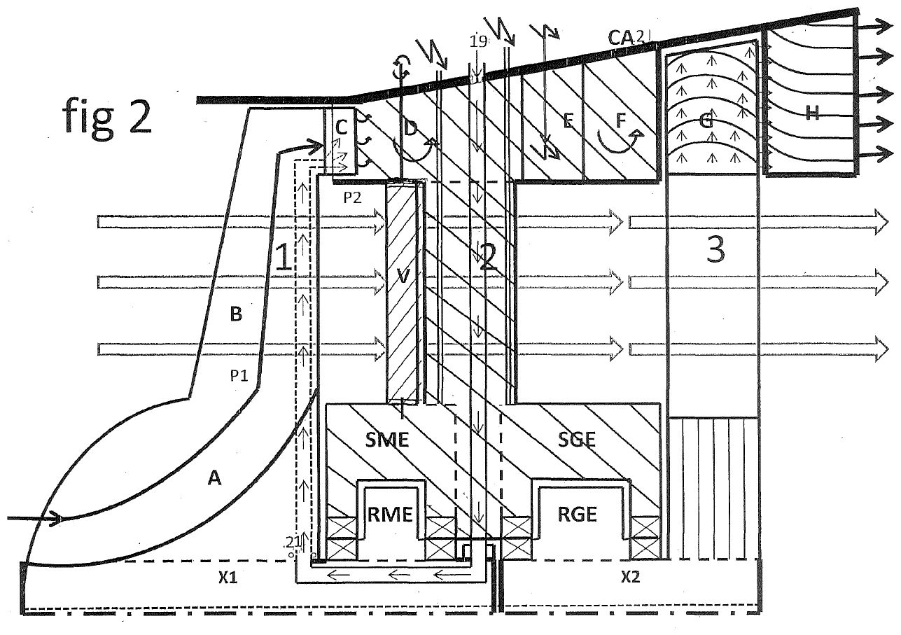

FIGS. 1 and 2 show the THRA wheel which takes the ambient fluid 12 to the front centre A which is then led p1 into the hollow blades of the propeller B and ends in the circular chamber C which propels it into the fixed chamber D, which makes it turn and introduces it into the chamber E with the fuel coming from outside the casing 16 and which is then pushed back into the chamber F, which makes it turn and sends it into the buckets of the bucket wheel or the scoops of the scoop wheel G which rotates and the fluid continues into the fixed chamber H which directs it before its exit from the engine towards the rear 20.

FIGS. 1 and 2 show in the centre the motor shaft X1 connected to the rotor of the RME motor which is extended after the motor with a diameter suitable to receive a bearing bushing L which is contained in the tube of

[symbol]

the hollow shaft X2 of the rotor of the power generator which is prolonged after the generator and then receives a disk D2. The extended shaft of the motor then also receives a disk D1 which when may be clamped 22 with that of the generator connecting the rotation of the two shafts as required.

FIG. 2 shows that the supply of fuel sprayed into the chamber D comes from the circular chamber C P2 which receives it by tubes that pass inside the hollow blades B of the propeller of the THRA wheel which are fed by the shaft 21 of the motor pierced so as to receive it by tubes which are integrated in the radial blades 2 and are fed 19 through the fixed chamber D and the casing. FIG. 2 shows that the engine casing is flared CA2 or narrowed towards the rear as required in order to adapt the usable surface required by the buckets or scoops G.

FIG. 4 shows the arrangement used so that the bucket wheel or scoop wheel G rotates the motor shaft X3 connected to the RGE rotor of a power generator whose SGE stator 10 is connected and fixed to the outside of the fixed chamber E.

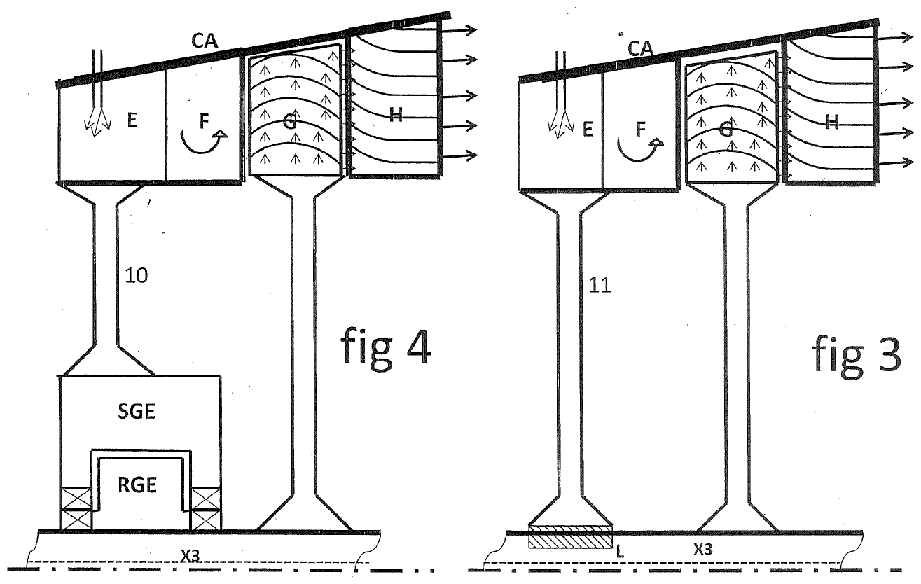

FIG. 3 shows the arrangement used for the bucket wheel or scoop wheel G to rotate the shaft X3 in a bearing L whose fixed ring is connected 11 and fixed inside the fixed chamber E.

FIG. 1 also shows a wheel V provided with independent profiled radial blades that is interposed, mounted on pivots between the chamber D and the stator of the SME motor whose blades are adjustable by a rod 14.

1-11. (canceled)

12. A method for constructing engines or motors contained in a cylindrical casing (CA1),
characterized by the fact that they use a wheel of the THRA 1 Powered Turboprop Engine type coupled to an SME+RME electric motor and at least one wheel of the TaG 3 Bucket Turbine type or at least one scoop wheel of the TaC type which is coupled to an SGE+RGE power generator, either to a TaG bucket-type wheel or a TaC scoop-type wheel, alone or combined, and that they use the forces provided to them by electrical power or fuel that is introduced from the outside through orifices in the casing 16-19 through the peripheral chambers D and E or in the center of the THRA, and
by the fact that they first use a wheel of the THRA Powered Turboprop Engine type, in that the ambient fluid between 12 first at the front at the center of the wheel A, whose direction of rotation right or left is predetermined by the designer, and continues its way in the inner channels B of the hollow blades of the propeller located in the center of the wheel 1 which blows backwards and whose blades reach their largest diameter at a circular peripheral chamber C provided with at least one circular slot open towards the rear of the wheel, this wheel being rotated at the rear in the center by the shaft X1 of the rotor of an electric SME+RME motor which is preferably pierced by a hole with a small diameter 13 in its center from side to side, the jets of fluid projected by the slots of the chamber of the wheel C being received by circular slots placed in line opposite in the bore of the entrance to the fixed cylindrical hollow chamber glued to the casing D, and the channels, formed by the slots which are provided with profiled blades placed inside between the cylindrical walls and determine the direction of rotation of the fluid supplied by the chamber C, and in that a set of hollow radial profiled fixed blades 2 passes through the chamber fixed to the casing D, and will then become firmly attached to the stators of the SME electric motor and the SGE power generator which are placed at the center of the wheel, the hollow interior of these profiled fixed blades allowing the passage of the layer of electric wires 15-17 for the stators, the SME electric motor and the SGE power generator.

13. The method for constructing engines according to claim 12, characterized in that at the outlet of the first front circular chamber fixed to the casing D the fluid received from the slots of the chamber C continues by turning in the fixed circular chamber E which receives the fuel or fuels introduced via orifices 16 from outside the engine casing, and which are immediately diffused in the chambers, in that in the case of using flammable fuels, the chambers are provided with electric sparking devices 18, the first two chambers are followed by another fixed circular cylindrical chamber F fixed to the casing which is provided inside with tubes that are concentric to the axis of the wheel placed one inside the other and spirally wound radial blades placed inside between the cylindrical walls of this chamber which form channels where they intersect which each individually direct the flow of fuel by rotating towards the rear of the wheel.

14. The method for constructing engines according to claim 12, characterized in that the chamber F sends the jets of the fuel through its channels, turning along the channels the buckets of a wheel of the Bucket Turbine G type or the scoops of a wheel of the TaC Scoop Turbine type, which are placed in a circular manner in line with the outlet of the channels of the chamber F, the buckets or the scoops as they turn globally describing virtual cylindrical crowns, the center of these crowns often being occupied by a propeller that blows backwards 3 and strengthens the flow provided by the THRA 1 wheel, in that this propeller is fixed in the center on the shaft X2 of the rotor of the RGE power generator, the stator of the SGE power generator is connected to the stator of the SME electric motor of the THRA type wheel and they are connected to the chamber fixed to the casing D by hollow profiled fixed radial blades that let the central flow 2 of the propeller of the THRA type wheel pass through and get directed, and in that these profiled hollow blades allow the passage inside them of the layer of electric wires for the engine and for the generator 15-17, a wheel V provided with independent profiled radial blades being optionally interposed and mounted on pivots between the chamber D and the stator of the SME engine and its blades being adjustable by a rod 14 coming from the outside of the casing through D.

15. The method for constructing engines according to claim 13, characterized in that the chamber F sends the jets of the fuel through its channels, turning along the channels the buckets of a wheel of the Bucket Turbine G type or the scoops of a wheel of the TaC Scoop Turbine type, which are placed in a circular manner in line with the outlet of the channels of the chamber F, the buckets or the scoops as they turn globally describing virtual cylindrical crowns, the center of these crowns often being occupied by a propeller that blows backwards 3 and strengthens the flow provided by the THRA 1 wheel, in that this propeller is fixed in the center on the shaft X2 of the rotor of the RGE power generator, the stator of the SGE power generator is connected to the stator of the SME electric motor of the THRA type wheel and they are connected to the chamber fixed to the casing D by hollow profiled fixed radial blades that let the central flow 2 of the propeller of the THRA type wheel pass through and get directed, and in that these profiled hollow blades allow the passage inside them of the layer of electric wires for the engine and for the generator 15-17, a wheel V provided with independent profiled radial blades being optionally interposed and mounted on pivots between the chamber D and the stator of the SME engine and its blades being adjustable by a rod 14 coming from the outside of the casing through D.

16. The method for constructing engines according to claim 12, characterized in that the shaft X1 of the rotor of the RME electric motor is reduced in diameter towards the rear at its outlet from the engine and enters the inside of the tube of the rotor shaft X2 of the RGE power generator provided with bearings L in order to maintain the shafts concentrically inside one another, in that the rotor shaft of the electric motor which is decreased in diameter X1 continues through the cased shaft of the power generator X2 which receives a rotating disk plate D2 at its outlet from the power generator, in that the shaft of the electric motor also receives, as soon as possible afterwards, another rotating disk D1 which when clamped together remotely by electrically remote controlled devices 22 which makes it possible to join the rotation of the two shafts as required, an electrical variant making it possible to regulate by means of the frequency converter used to control the speed of the electric motor, depending on the speed of the power generator possibly controlled by the encoder and/or the electrical power it emits in order to synchronize together the rotation speeds of the shafts X1 X2 as best possible.

17. The method for constructing engines according to claim 13, characterized in that the shaft X1 of the rotor of the RME electric motor is reduced in diameter towards the rear at its outlet from the engine and enters the inside of the tube of the rotor shaft X2 of the RGE power generator provided with bearings L in order to maintain the shafts concentrically inside one another, in that the rotor shaft of the electric motor which is decreased in diameter X1 continues through the cased shaft of the power generator X2 which receives a rotating disk plate D2 at its outlet from the power generator, in that the shaft of the electric motor also receives, as soon as possible afterwards, another rotating disk D1 which when clamped together remotely by electrically remote controlled devices 22 which makes it possible to join the rotation of the two shafts as required, an electrical variant making it possible to regulate by means of the frequency converter used to control the speed of the electric motor, depending on the speed of the power generator possibly controlled by the encoder and/or the electrical power it emits in order to synchronize together the rotation speeds of the shafts X1 X2 as best possible.

18. The method for constructing engines according to claim 14, characterized in that the shaft X1 of the rotor of the RME electric motor is reduced in diameter towards the rear at its outlet from the engine and enters the inside of the tube of the rotor shaft X2 of the RGE power generator provided with bearings L in order to maintain the shafts concentrically inside one another, in that the rotor shaft of the electric motor which is decreased in diameter X1 continues through the cased shaft of the power generator X2 which receives a rotating disk plate D2 at its outlet from the power generator, in that the shaft of the electric motor also receives, as soon as possible afterwards, another rotating disk D1 which when clamped together remotely by electrically remote controlled devices 22 which makes it possible to join the rotation of the two shafts as required, an electrical variant making it possible to regulate by means of the frequency converter used to control the speed of the electric motor, depending on the speed of the power generator possibly controlled by the encoder and/or the electrical power it emits in order to synchronize together the rotation speeds of the shafts X1 X2 as best possible.

19. The method for constructing engines according to claim 12, characterized in that the fixed casing of the engine is extended towards the rear and covers the rotary bucket wheel TaG or scoop wheel TaC and is then secured to a fixed chamber H which is placed in line with the outlet flow of the TaG bucket wheel and is provided with concentric tubes placed one inside another in accordance with those of the bucket wheel and provided with spiral profiled blades placed inside between the cylindrical walls of this chamber which form channels that direct the outward direction of the fluid towards the rear of the engine 20.

20. The method for constructing engines according to claim 13, characterized in that the fixed casing of the engine is extended towards the rear and covers the rotary bucket wheel TaG or scoop wheel TaC and is then secured to a fixed chamber H which is placed in line with the outlet flow of the TaG bucket wheel and is provided with concentric tubes placed one inside another in accordance with those of the bucket wheel and provided with spiral profiled blades placed inside between the cylindrical walls of this chamber which form channels that direct the outward direction of the fluid towards the rear of the engine 20.

21. The method for constructing engines according to claim 14, characterized in that the fixed casing of the engine is extended towards the rear and covers the rotary bucket wheel TaG or scoop wheel TaC and is then secured to a fixed chamber H which is placed in line with the outlet flow of the TaG bucket wheel and is provided with concentric tubes placed one inside another in accordance with those of the bucket wheel and provided with spiral profiled blades placed inside between the cylindrical walls of this chamber which form channels that direct the outward direction of the fluid towards the rear of the engine 20.

22. The method for constructing engines according to claim 12, characterized in that the engine casing is no longer constantly cylindrically straight, but has a diameter that flares CA2 or narrows towards the rear, modifying the effective energy exchange surface of the buckets of the TaG bucket wheel or the scoops of the TaC scoop wheel with the fuel.

23. The method for constructing engines according to claim 16, characterized in that the engine casing is no longer constantly cylindrically straight, but has a diameter that flares CA2 or narrows towards the rear, modifying the effective energy exchange surface of the buckets of the TaG bucket wheel or the scoops of the TaC scoop wheel with the fuel.

24. The method for constructing engines according to claim 12, characterized in that in this case the supply of fuel into the chambers is carried out starting from the outside of the casing of the engine 19 by at least one channel that passes through the fixed chamber glued to the casing D and continues through the fixed profiled hollow blades 2 which go up to the rotor shaft of the electric motor X2 to which they are connected by a small chamber placed between two circular seals, in that the shaft is pierced radially at this point and in communication with at least one hole parallel to the axis of the shaft which radially communicate with tubes which enter the THRA wheel, and in that, alternatively, a direct supply may be located at this point 21, and they reach the sprayers placed in the peripheral chamber of the wheel C which send either jets or mists of fuel turning in the channels of the fixed chamber D, where the orientation of the blades defines the direction of rotation of the fluids.

25. The method for constructing engines according to claim 13, characterized in that in this case the supply of fuel into the chambers is carried out starting from the outside of the casing of the engine 19 by at least one channel that passes through the fixed chamber glued to the casing D and continues through the fixed profiled hollow blades 2 which go up to the rotor shaft of the electric motor X2 to which they are connected by a small chamber placed between two circular seals, in that the shaft is pierced radially at this point and in communication with at least one hole parallel to the axis of the shaft which radially communicate with tubes which enter the THRA wheel, and in that, alternatively, a direct supply may be located at this point 21, and they reach the sprayers placed in the peripheral chamber of the wheel C which send either jets or mists of fuel turning in the channels of the fixed chamber D, where the orientation of the blades defines the direction of rotation of the fluids.

26. The method for constructing engines according to claim 13, characterized in that the energy products introduced from outside the casing of the engine 16 into the chamber E are either gaseous or liquid or partially solid, and by combustion or chemical reactions or by their temperature, such as high-pressure water vapor, can locally generate large fluid pressures that will migrate to the chamber F and will at the outlets of the channels by turning activate the buckets of the TaG bucket wheel or the TaC scoop wheel.

27. A method for constructing motors according to claim 12, characterized in that the energy products introduced from outside the propeller casing 161 into the chamber E will activate the buckets of the TaG bucket wheel or the scoops of the TaC scoop wheel which is connected and secured at its center (10) by a propeller with the shaft X3, this shaft being either that of the rotor of a power generator whose stator is connected 11 to the outer edge of the chamber E, or it is used directly for mechanical use, and in this case a bearing L is located on the shaft whose fixed part is connected and secured to the outer edge of the chamber E.

28. A method for constructing motors according to claim 13, characterized in that the energy products introduced from outside the propeller casing 161 into the chamber E will activate the buckets of the TaG bucket wheel or the scoops of the TaC scoop wheel which is connected and secured at its center (10) by a propeller with the shaft X3, this shaft being either that of the rotor of a power generator whose stator is connected 11 to the outer edge of the chamber E, or it is used directly for mechanical use, and in this case a bearing L is located on the shaft whose fixed part is connected and secured to the outer edge of the chamber E.

29. A method for constructing motors according to claim 14, characterized in that the energy products introduced from outside the propeller casing 161 into the chamber E will activate the buckets of the TaG bucket wheel or the scoops of the TaC scoop wheel which is connected and secured at its center (10) by a propeller with the shaft X3, this shaft being either that of the rotor of a power generator whose stator is connected 11 to the outer edge of the chamber E, or it is used directly for mechanical use, and in this case a bearing L is located on the shaft whose fixed part is connected and secured to the outer edge of the chamber E.

30. A method for constructing motors according to claim 26, characterized in that the energy products introduced from outside the propeller casing 161 into the chamber E will activate the buckets of the TaG bucket wheel or the scoops of the TaC scoop wheel which is connected and secured at its center (10) by a propeller with the shaft X3, this shaft being either that of the rotor of a power generator whose stator is connected 11 to the outer edge of the chamber E, or it is used directly for mechanical use, and in this case a bearing L is located on the shaft whose fixed part is connected and secured to the outer edge of the chamber E.
